(19) United States
(12) Patent Application Publication
(10) Pub. No.: US 2006/0280132 A1
(43) Pub. Date: Dec. 14, 2006

(54) Techniques to identify duplex mismatch

(75) Inventor: Patrick L. Connor, Portland, OR (US)

Correspondence Address: INTEL CORPORATION;c/o INTELLEVATE, LLC, P.O. BOX 52050, MINNEAPOLIS, MN, 55402, US

(73) Assignee: Intel Corporation

(21) Appl. No.: 11/149,677

(22) Filed: Jun. 9, 2005

(51) Int. Cl. H04L 5/14; H04L 12/413

(52) U.S. Cl. 370/276; 370/445

(57) ABSTRACT

Techniques to determine the presence of conditions that could occur when link partners that are duplex-mismatched. For example, conditions may be detected that are likely to occur in a duplex-mismatched environment. The conditions may be transmitted to an administrator or otherwise made available for inspection. In some cases, a duplex mode of one of the link partners may be changed.

### FIELD

The subject matter disclosed herein relates to techniques to identify duplex mismatch.

### RELATED ART

Auto-negotiation is a protocol that allows Ethernet compliant link partners to connect at the highest common denominator of link speed and duplex. For descriptions of auto-negotiation see, for example, clauses 28, 30, and 37 of IEEE standard 802.3-2002. Under auto-negotiation, when a device port configured for auto-negotiation is connected to a network, the device and its link partner exchange low-level network messages (link pulses) to help determine the right communication speed as well as duplex mode to use. In the case one link-partner is not set to auto-negotiate and the other link partner auto-negotiates, the auto-negotiating link-partner can correctly determine the speed of its link-partner, but not the duplex. In this scenario, the auto-negotiating link partner may be required to configure itself for half duplex operation regardless of the actual duplex mode of its non-auto-negotiating link partner. Accordingly, link partners may operate at different duplex modes thereby resulting in duplex mismatch. Duplex mismatch can cause undesirable effects in a network.

### BRIEF DESCRIPTION OF THE DRAWINGS

Embodiments of the present invention are illustrated by way of example, and not by way of limitation, in the figures of the accompanying drawings and in which like reference numerals refer to similar elements and in which:

FIG. 1 illustrates a plurality of network nodes.

FIG. 2 depicts examples of link partners in accordance with some embodiments of the present invention.

FIGS. 3A and 3B depict examples of computing logic that could be used by a node in a link partnership, in accordance with some embodiments of the present invention.

FIGS. 4 and 5 depict example flow diagrams of processes in accordance with some embodiments of the present invention.

Note that use of the same reference numbers in different figures indicates the same or like elements.

### DETAILED DESCRIPTION

Reference throughout this specification to “one embodiment” or “an embodiment” means that a particular feature, structure, or characteristic described in connection with the embodiment is included in at least one embodiment of the present invention. Thus, the appearances of the phrase “in one embodiment” or “an embodiment” in various places throughout this specification are not necessarily all referring to the same embodiment. Furthermore, the particular features, structures, or characteristics may be combined in one or more embodiments.

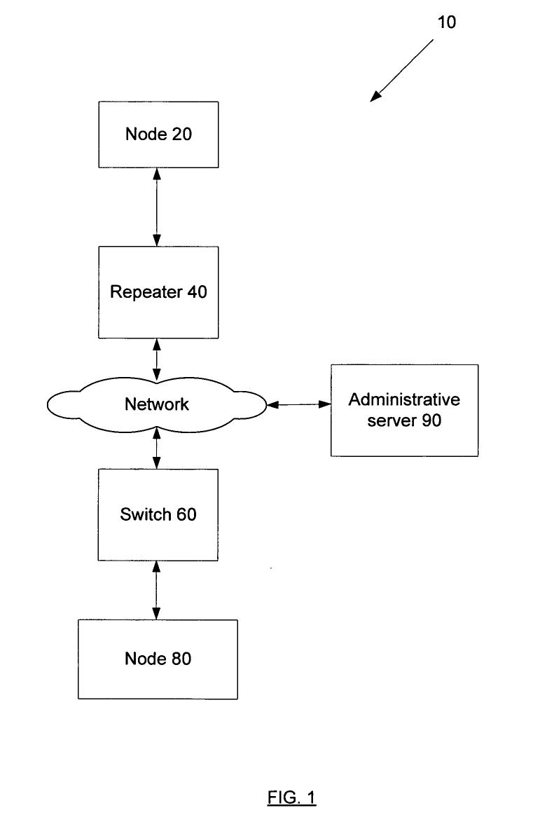

FIG. 1 illustrates a computer network 10 that interconnects a plurality of network nodes. For example, node 20 may intercommunicate with repeater 40 using any communications medium such as but not limited to wired or wireless mediums. For example, switch 60 may intercommunicate with node 80 using any communications medium. Node 20 and repeater 40 may be referred to as link partners. Similarly, switch 60 and node 80 may be referred to as link partners. Although not depicted, a single link partner may have multiple link partners.

Nodes 20 and 80 may be implemented as any computing device, such as but not limited to, a mainframe, server, personal computer, workstation, laptop, handheld computer, telephony device, network appliance, and storage controller.

Repeater 40 and switch 60 may intercommunicate using a network. Administrative server 90 may intercommunicate with any other node depicted in FIG. 1 using the network. The network may be any network such as the Internet, an intranet, a local area network (LAN), storage area network (SAN), a wide area network (WAN), or wireless network and utilize any communications protocol.

Either or both of node 20 and repeater 40 may have the capability to perform auto-negotiation in accordance at least with the IEEE 802.3 family of standards. Similarly, either or both of switch 60 and node 80 may have the capability to perform auto-negotiation in accordance at least with the IEEE 802.3 family of standards. Auto-negotiation may allow two link partners to connect at the highest common denominator of link speed and at a common duplex mode. As a result of successful auto-negotiation, at least a transmit rate and duplex mode (e.g., full or half-duplex) may be established for each node with auto-negotiation capability. Half-duplex refers to the transmission of data in just one direction at a time by a link partner. Full-duplex refers to permitted transmission of data in two directions simultaneously by link partners.

An auto-negotiating node may configure itself for half duplex operation if auto-negotiation fails. For example, auto-negotiation may fail if one link partner is malfunctioning, one link partner is set to auto-negotiate and the other is not set to auto-negotiate, or a link partner is forced to operate in a particular duplex mode. For example, if one link partner is manually configured to operate in full duplex mode, while the other link partner is trying to auto-negotiate the connection, duplex mismatch between link partners will result in one link partner operating at half-duplex with the other link partner operating at full-duplex. A “connection” may include a sender and destination connection partner to receive packets from the sender through any number or configuration of link partners.

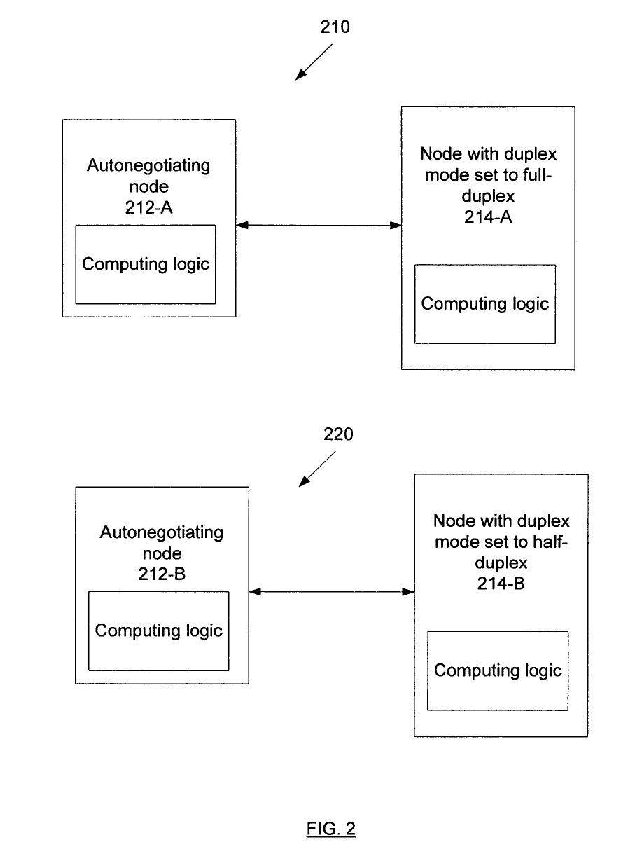

FIG. 2 depicts non-limiting examples of link partners, although other scenarios can be used. In scenario 210, auto-negotiating node 212-A is a link partner with node 214-A. In this example, the auto-negotiating capability of node 214-A is unavailable, disabled, or malfunctions. In scenario 210, auto-negotiating node 212-A is set to auto-negotiate whereas the duplex mode of node 214-A is set to full-duplex. Accordingly, duplex mismatch may result between nodes 212-A and 214-A.

In scenario 220, auto-negotiating node 212-B is a link partner with node 214-B. In this example, the auto-negotiating capability of node 214-B is unavailable, disabled, or malfunctions. In this example, auto-negotiating node 212-B is set to auto-negotiate whereas the duplex mode of node 214-B is set to half-full duplex. Accordingly, duplex mismatch may result between nodes 212-B and 214-B.

In some embodiments, each of nodes 212-A, 214-A, 212-B, and 214-B includes computing logic capable of providing intercommunication with at least one link partner. Some implementations of the computing logic may include the capability to perform auto-negotiation with at least one link partner. In accordance with some embodiments of the present invention, the computing logic may include the capability to determine the occurrence of duplex mismatch, to generate a record of symptoms of potential duplex mismatch, and/or to selectively adjust a duplex mode to result in duplex mode match with a link partner.

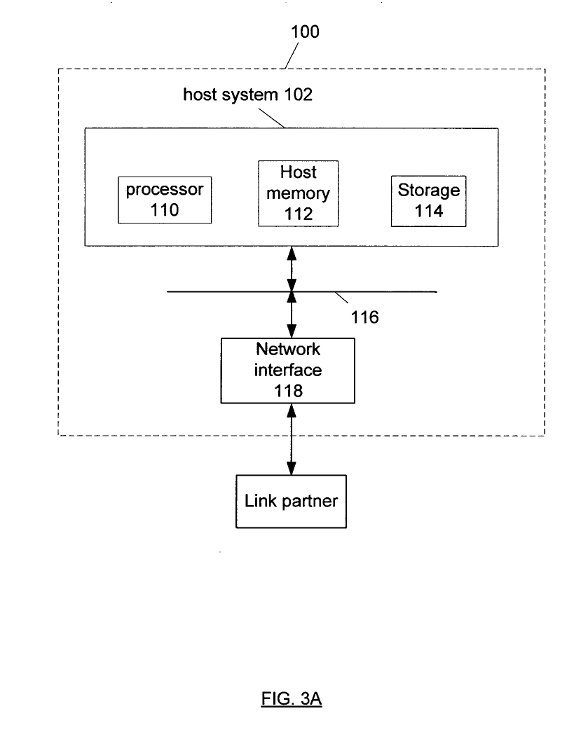

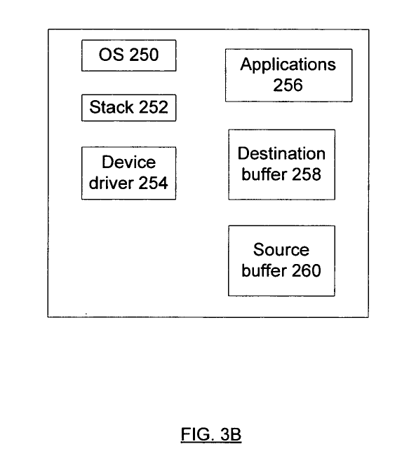

For example, FIGS. 3A to 3B depict examples of computing logic that could be used by a node in a link partnership, although other computing logic may be used. FIG. 3A depicts an example computer system that includes host system 102, bus 116, and network interface 118.

Host system 102 may include processor 110, host memory 112, and storage 114. Processor 110 may be implemented as Complex Instruction Set Computer (CISC) or Reduced Instruction Set Computer (RISC) processors, multi-core, or any other microprocessor or central processing unit. Host memory 112 may be implemented as a volatile memory device such as but not limited to a Random Access Memory (RAM), Dynamic Random Access Memory (DRAM), or Static RAM (SRAM). Storage 114 may be implemented as a non-volatile storage device such as but not limited to a magnetic disk drive, optical disk drive, tape drive, an internal storage device, an attached storage device, and/or a network accessible storage device.

Bus 116 may provide intercommunication among at least components of host system 102 and network interface 118 as well as other peripheral devices (not depicted). Bus 116 may support serial or parallel communications. Bus 116 may support node-to-node or node-to-multi-node communications. Bus 116 may be compatible with Peripheral Component Interconnect (PCI) described for example at Peripheral Component Interconnect (PCI) Local Bus Specification, Revision 2.2, Dec. 18, 1998 available from the PCI Special Interest Group, Portland, Oreg., U.S.A. (as well as revisions thereof); PCI Express described in The PCI Express Base Specification of the PCI Special Interest Group, Revision 1.0a (as well as revisions thereof); PCI-x described in the PCI-X Specification Rev. 1.0a, Jul. 24, 2000, available from the aforesaid PCI Special Interest Group, Portland, Oreg., U.S.A. (as well as revisions thereof); and/or Universal Serial Bus (USB) (and related standards) as well as other interconnection standards.

Network interface 118 may be capable of providing intercommunication between host system 102 and at least one link partner (as well as a network) in compliance with relevant protocols such as but not limited to the Ethernet standard (described in IEEE 802.3 and related standards). Network interface 118 may intercommunicate with host system 102 using bus 116. In one embodiment, network interface 118 may be integrated into host system 102.

Network interface 118 may include any combination of hardware and/or software on an I/O (input/output) subsystem that may process one or more packets sent to and/or received from a link partner. For example, network interface 118 may include the capability to transmit/receive packets to/from a link partner. As used herein, a “packet” means a sequence of one or more symbols and/or values that may be encoded by one or more signals transmitted from at least one sender to at least one receiver. In one embodiment, the I/O subsystem may include, for example, a NIC (network interface card), and network interface may include, for example, a MAC (media access control) layer of the Data Link Layer as defined in the Open System Interconnection (OSI) model for networking protocols. The OSI model is defined by the International Organization for Standardization (ISO) located at 1 rue de Varembé, Case postale 56 CH-1211 Geneva 20, Switzerland.

Some embodiments of network interface 118 may include logic with the capability to determine the occurrence of duplex mismatch, to generate a record of symptoms of potential duplex mismatch, and/or to selectively adjust a duplex mode to result in duplex mode match with a link partner.

FIG. 3B depicts machine executable instructions as well as buffers that could be used by computing logic such as but not limited to that described with regard to FIG. 3A. For example, the following machine-executable instructions may be used: operating system (OS) 250, stack 252, device driver 254, and applications 256. For example, the machine-executable instructions may be executed by processor 110 or other logic. For example, the buffers may include destination buffer 258 and source buffer 260.

Suitable embodiments of OS 250 include, but are not limited to, operating systems compatible with Linux® or Microsoft Windows®, although any operating system may be used.

Stack 252 may perform protocol processing at least on packets received from a link partner in accordance with TCP/IP protocol specifications. For example, the TCP/IP protocol is described at least in the publication entitled “Transmission Control Protocol: DARPA Internet Program Protocol Specification,” prepared for the Defense Advanced Projects Research Agency (RFC 793, published September 1981). Stack 252 may at least generate protocol related information for packets in accordance with relevant standards such as TCP/IP and initiate the transfer of packets from source buffer 260 to the network interface for transmission to a link partner. In some embodiments, stack 252 may be incorporated into operating system 250.

Device driver 254 may be a device driver for a network interface. Device driver 254 may at least coordinate the transfer of packets (or portions thereof) as well as other information between host system and network interface. Some embodiments of device driver 254 may include the capability to determine the occurrence of duplex mismatch, to generate a record of symptoms of potential duplex mismatch, and/or to selectively adjust a duplex mode to result in duplex mode match with a link partner.

Applications 256 can be one or more machine-executable instructions that may utilize data at least received from a link partner or issue a request to transfer data to a link partner. An application may include, but not be limited to, for example, a web browser, input/output filter, an e-mail serving application, a file serving application, or a database application.

Destination buffer 258 may store data (e.g., packets (or portions thereof)) received by a network interface for example from a link partner. Source buffer 260 may store packets capable of being transmitted to a link partner.

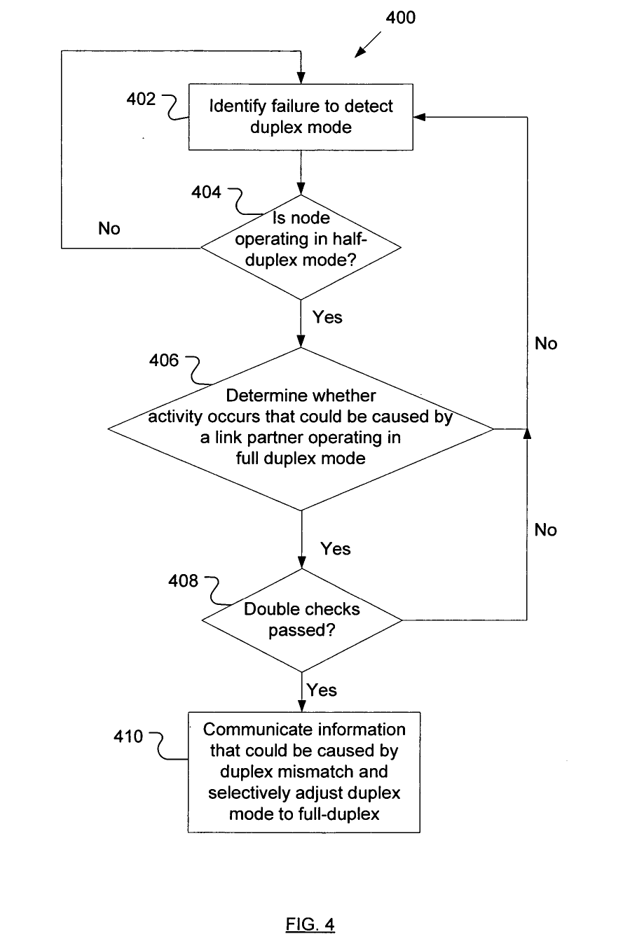

FIG. 4 depicts an example flow diagram of a process 400 in accordance with some embodiments of the present invention. For example, process 400 may be used by a node that fails to detect a duplex mode of its link partner. In some embodiments, process 400 may be used by a node configured to operate in half-duplex mode with a link partner. For example, the duplex mode may be set using a system configuration tool such as, but not limited to, “control panel” or its equivalent in the Windows® operating system or using the “ethtool” or its equivalent under the Linux® operating system. For example, the node may have auto-negotiation enabled but auto-negotiation with the link partner failed. However, the node may otherwise operate in half duplex mode. For example, the link partner may have auto-negotiation enabled and operate in half-duplex mode as a result of failed auto-negotiation with the node, be manually configured to operate in half or full duplex mode, or otherwise operate in half or full duplex mode. The process of FIG. 4 can be applied between the node and one or more link partners.

In block 402, process 400 may identify a failure of a node to detect duplex mode of its link partner. For example, failure to detect duplex mode may occur when the node fails to successfully auto-negotiate with its link partner. For example, auto-negotiation may fail when the link partner does not use auto-negotiation or the link partner malfunctions. For example, auto-negotiation may fail when the duplex mode of the link partner is manually configured. For example, manual configuration may occur by adjusting logic in the link partner so that operation is a particular duplex mode. Causes of failure to detect duplex mode of the link partner are not limited in these respects.

In block 404, process 400 may identify that the node is operating in half-duplex mode. In some embodiments, if auto-negotiation fails between the node and its link partner, the node may default to half-duplex mode. However, the node may otherwise be configured to operate in half-duplex mode. If the node is operating in half-duplex mode, the process may proceed to block 406. If the node is not operating in half-duplex mode, the process may revert to block 402.

In block 406, process 400 may determine whether activity occurs that could be caused by the link partner operating in full duplex mode. For example, block 406 may include a determination whether excess late collisions occur. A “collision” may occur when two devices transmit at approximately the same instance and the signals from both devices collide. When a collision occurs, the signals distort and portions of both of the signals may be lost. Although not limited in this respect, a late collision may result when packet collision occurs after the first sixty-four (64) bytes of any transmitted packet. A determination of excess late collisions may be based on a ratio of transmit attempts to number of late collisions. Determining what constitutes “excessive” may be environment specific. In homogeneous network environments, where compatibility issues are uncommon, a small number of late collisions may be excessive. The definition of “excessive” late collisions for changing the node from half duplex to full duplex may be set to prevent link partners from toggling modes at the same time, thereby continuing to be mis-configured.

If the link partner operates in half duplex mode, late collisions are unlikely because only one of the node and its link partner transmit over the medium at any time. If the link partner operates in full duplex mode, collisions of signals transmitted by the link partner with signals transmitted by the half-duplex node are more likely. Excess late collisions may indicate the link partner is operating in full duplex. Accordingly, if excessive late collisions occur, a duplex mismatch may be present between the node that operates in half-duplex mode and the link partner which may operate in full-duplex mode. However, late collisions may be caused by a malfunctioning link partner or excessively long cable lengths. Accordingly, excess late collisions could occur where both the node and its link partner operate in half duplex mode. In some embodiments, additional checks may be utilized such as those in block 408. Accordingly, if excess late collisions occur, block 408 may follow block 406. If excess late collisions do not occur, block 402 may follow block 406.

In block 408, process 400 may perform additional checks of whether activity occurs that could be caused by a link partner operating in full duplex mode. For example, block 408 may include determining whether the node and its link partner communicate using a shared media. Shared media are likely used for half duplex mode communications. A shared media may be a communications medium that provides intercommunication between two or more nodes. A shared media may for example be a communications medium shared by multiple link partners. For example, a shared media may be a wire or wireless medium. For example, a shared media may be used where the link partner is for example, a repeater or hub.

For example, determining whether a shared media is used may include determining whether jam signals are monitored from nodes other than the node and its link partner. A “jam signal” is a specific data pattern that is broadcast when a collision occurs and is described for example in IEEE 802.3-2002. Devices that transmit packets that collided may each wait a random amount of time and then attempt to transmit again. In addition or alternatively, if late collisions concerning other nodes are present above a threshold amount for a given period of time, it is likely that a shared media is used and the late collisions are the result of other nodes being mis-configured.

For example, a media access controller (MAC) or other logic of the node has awareness of when its node transmits packets. If a jam signal or late collision results from a transmitted signal that was not sent by the node, a shared media may be used. Accordingly, changing duplex mode of the node to full-duplex is not likely to occur when a shared media is likely used between the node and its link partner. Accordingly, if conditions are present that likely indicate a shared media is being used, block 402 may follow. If conditions are present that likely indicate a shared media is not being used, block 410 may follow.

For example, block 408 may in addition or alternatively attempt to determine if a shared media or switch is involved in communication with the node. When a shared media is used, packets are transmitted to all nodes that use the shared media (so called “broadcast mode” ). Many shared media are used in half-duplex mode. If a switch is present, the switch performs filtering to route packets to proper destinations so the destination node will receive packets that are transmitted only to the destination node. A switch is likely used in full-duplex mode. Temporarily placing the media access controller (MAC) or other logic in the node to not filter packets may allow for an examination of the traffic present and can help determine if a switch is present (and accordingly, whether changing to full-duplex mode is appropriate).

If a switch is present, for unicast packets, the MAC may only receive unicast packets and accordingly, changing the duplex mode of the node to full-duplex mode may be appropriate. Unicast refers to transmission of a packet to a single destination. The MAC may receive broadcast traffic if a switch is not present. If traffic is broadcast, a shared media is likely used and half-duplex mode for the node may be appropriate. Each packet may identify whether it is unicast, broadcast or multicast. The MAC of other logic may collect a statistic such as Blocked Unicast Packet Count. A Blocked Unicast Packet Count may be a count of packets that were filtered (or blocked) by the MAC or other logic. The presence of Blocked Unicast Packets is an indication that the network is likely using shared media. Accordingly, if conditions are present that likely indicate a switch is being used, block 410 may follow. If conditions are present that likely indicate a shared media is being used, block 402 may follow.

In block 410, process 400 may communicate information that could be caused by duplex mismatch and selectively adjust duplex mode of the node to full duplex. For example, an event log may be generated that can inform a user of excess late collisions and possible causes of late collisions (e.g., use of a shared media). For example, an instruction to check whether cable length between a node and its link partner is excessive may be rendered. An excessively long cable may result in a detection of duplex mismatch. For example, Blocked Unicast Packet Count may be recorded and/or communicated. For example, block 410 may include generating a record of symptoms of potential duplex mismatch. A “record” may include an identification of symptoms determined during process 400 and that may be caused by duplex mismatch as well as other information communicated during block 410, although the record is not limited in this regard. The record may be stored in a memory space, transmitted to an administrator, displayed using any display device, or indicated using a light-emitting-diode from the exterior of a network interface. For example, the record may be used to determine whether a link partner is manually configured to operate in a particular duplex mode as opposed to set to auto-negotiate.

For example, Alert Standard Format (ASF) and Simple Network Management Protocol (SNMP) compliant alerts may be transmitted to an administrative server so that information determined in process 400 (including, without limitation, the record) can be viewed by an administrator.

For example, a visible display (such as but not limited to a flashing light from a light emitting diode emitted from a network interface) may be provided of a corrective action of a duplex-mode adjustment, as well as link up/down indication and/or auto-negotiation activity.

In some embodiments, in block 410, if the administrator permits, or by direction of logic located in the node or elsewhere, the node may switch to full duplex mode.

If errors continue after a duplex mode correction is attempted, the node could reinitiate auto-negotiation in an attempt to alleviate the problem. This periodic re-auto-negotiation could also cause a flashing light of a link indication on the exterior of the auto-negotiating device to provide a visible indication of auto-negotiation.

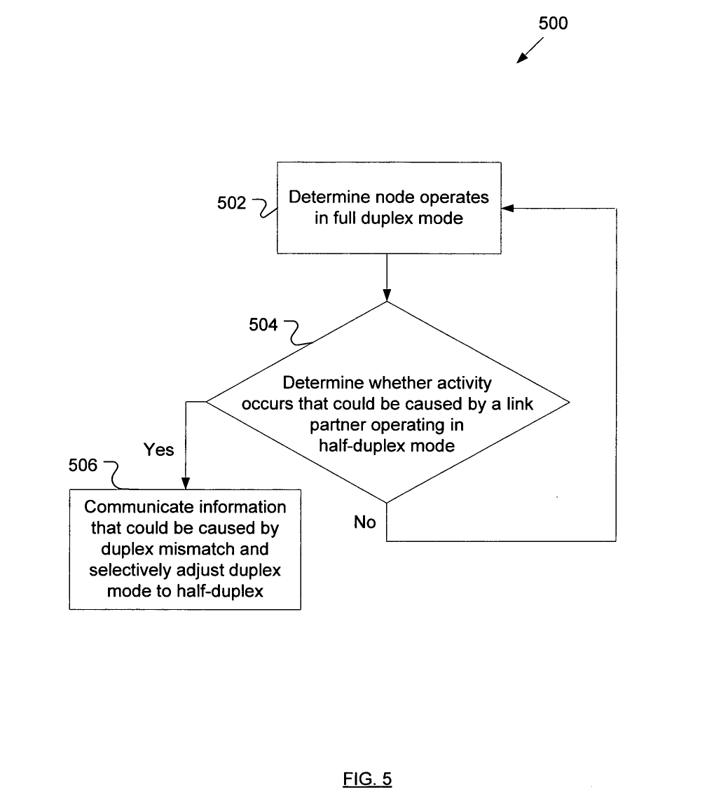

FIG. 5 depicts an example flow diagram of a process 500 in accordance with some embodiments of the present invention. Process 500 may be used by a node that operates in full duplex mode. For example, the node may be manually configured to operate in full-duplex mode with a link partner. For example, manual configuration of duplex mode may occur by setting parameters of a network application setting so that full-duplex mode is used and/or disabling auto-negotiation features. For example, the duplex mode may be set using a system configuration tool such as, but not limited to, “control panel” or its equivalent in the Windows® operating system or using the “ethtool” or its equivalent under the Linux® operating system. However, the node may be otherwise configured to operate in full duplex mode. The link partner may be set to auto-negotiate and operate in half-duplex as a result of failed auto-negotiation, be manually configured to operate in full or half-duplex mode, or otherwise operate in half or full duplex mode. The process of FIG. 5 can be applied between the node and one or more link partners.

In block 502, process 500 may determine that the node operates in full-duplex mode.

In block 504, process 500 may determine whether activity occurs that could be caused by the link partner operating in half-duplex mode. For example, block 504 may include detection of whether excessive collisions occur. If the link partner is operating in full-duplex mode, collisions are not likely to occur.

For example, block 504 may in addition or alternatively include detection of excessive jam signals generated by the link partner. A “jam signal” is a specific data pattern that is broadcast when a collision occurs. Collisions are not likely to occur on a correctly configured full duplex connection. If the full duplex node detects excessive jam signals, the duplex mode of the node may be mis-configured.

For example, block. 504 may in addition or alternatively include transmitting packets from the node in such a manner that excessive jam signals would likely result if the link partner were operating in half-duplex mode. For example, when a packet is not available for transmission from the node, transmission of a no-operation (NOP) packet from the node could cause a jam signal if transmitted while another packet is being received. Examples of NOP packets include but are not limited to a “transmit on” (XON) flow control packet when the node is not in a transmit pause mode (described for example in IEEE standard 802.3u-1995) and an extra Address Resolution Protocol (ARP) packet (described in the TCP/IP protocol). If the duplex mode of the link partner is full duplex, collisions or jam signals are unlikely to occur. If collisions occur, then the link partner may be operating in half-duplex mode. This technique may allow the node to determine if its duplex mode were configured correctly faster than if it were to wait to detect excessive collisions or jam signals when packets are available to transmit.

For example, block 504 may in addition or alternatively include detecting excessive quantities of error in a cyclical redundancy checking (CRC) field of packets received by the node. The CRC field may be the last four (4) bytes of a packet. Packets transmitted could have collided so the CRC value of the packet is not transmitted or otherwise corrupted. Accordingly, if an excessive number of CRC fields of packets received by the node are corrupted or absent, then the link partner may operate in half-duplex mode.

For example, block 504 may in addition or alternatively include detection of excessive quantities of runt frames. Runt frames may be less than sixty-four (64) bytes long, although other threshold sizes may be used. Accordingly, if excessive quantities of runt frames are detected by the node, then the link partner may operate in half-duplex mode.

Determining what constitutes “excessive” may be environment specific. In homogeneous network environments, where compatibility issues are uncommon, a small number of collisions, jam signals, corrupted or absent CRC fields, or runt frames may be considered excessive. The definition of “excessive” that would result in changing the duplex mode from of the node from full duplex to half duplex may be set to prevent link partners from toggling modes at the same time, thereby continuing to be mis-configured.

In block 506, process 500 may communicate information that could be caused by a link partner operating in half duplex and selectively adjust duplex mode of the node to half duplex. For example, an event log may be generated that can inform a user of a number of collisions, jam signals, corrupted or absent CRC fields, or runt frames or whether excessive numbers of collisions, jam signals, corrupted or absent CRC fields, or runt frames occur. For example, an instruction to check whether cable length is excessive may be rendered. An excessively long cable may result in a detection of duplex mismatch. For example, block 506 may include generating a record of symptoms of potential duplex mismatch. A “record” may include an identification of symptoms determined during process 500 and that may be caused by duplex mismatch as well as other information communicated during block 506, although the record is not limited in this regard. The record may be stored in a memory space, transmitted to an administrator, displayed using any display device, or indicated using a light-emitting-diode from the exterior of a network interface. For example, the record may be used to determine whether a link partner is manually configured to operate in a particular duplex mode as opposed to set to auto-negotiate.

For example, Alert Standard Format (ASF) and Simple Network Management Protocol (SNMP) compliant alerts may be transmitted to an administrative server so that information determined in process 500 (including, without limitation, the record) can be viewed by an administrator.

For example, a visible display (such as but not limited to a flashing light from a light emitting diode emitted from a network interface) may be provided of a corrective action of a duplex-mode adjustment, as well as link up/down indication and/or auto-negotiation activity.

In some embodiments, in block 506, if the administrator permits, or by direction of logic located in the node or elsewhere, the node may switch to half-duplex mode.

If errors continue after a duplex mode correction is attempted, the node could reinitiate auto-negotiation in an attempt to alleviate the problem. This periodic re-auto-negotiation could also cause a flashing light of a link indication on the exterior of the auto-negotiating device to provide a visible indication of auto-negotiation.

Embodiments of the present invention may be implemented as any or a combination of: microchips or integrated circuits interconnected using a motherboard, hardwired logic, software stored by a memory device and executed by a microprocessor, firmware, an application specific integrated circuit (ASIC), and/or a field programmable gate array (FPGA). The term “logic” may include, by way of example, software or hardware and/or combinations of software and hardware.

Embodiments of the present invention may be provided, for example, as a computer program product which may include one or more machine-readable media having stored thereon machine-executable instructions that, when executed by one or more machines such as a computer, network of computers, or other electronic devices, may result in the one or more machines carrying out operations in accordance with embodiments of the present invention. A machine-readable medium may include, but is not limited to, floppy diskettes, optical disks, CD-ROMs (Compact Disc-Read Only Memories), and magneto-optical disks, ROMs (Read Only Memories), RAMs (Random Access Memories), EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

Moreover, embodiments of the present invention may also be downloaded as a computer program product, wherein the program may be transferred from a remote computer (e.g., a server) to a requesting computer (e.g., a client) by way of one or more data signals embodied in and/or modulated by a carrier wave or other propagation medium via a communication link (e.g., a modem and/or network connection). Accordingly, as used herein, a machine-readable medium may, but is not required to, comprise such a carrier wave.

The drawings and the forgoing description gave examples of the present invention. Although depicted as a number of disparate functional items, those skilled in the art will appreciate that one or more of such elements may well be combined into single functional elements. Alternatively, certain elements may be split into multiple functional elements. Elements from one embodiment may be added to another embodiment. For example, orders of processes described herein may be changed and are not limited to the manner described herein. The scope of the present invention, however, is by no means limited by these specific examples. Numerous variations, whether explicitly given in the specification or not, such as differences in structure, dimension, and use of material, are possible. The scope of the invention is at least as broad as given by the following claims.

What is claimed is:

1. A method comprising:
identifying an operating duplex mode of a first node;
monitoring at least one condition potentially associated with duplex mismatch between the first node and a second node; and
providing a record of the at least one condition.

2. The method of claim 1, wherein the operating duplex mode of the first node is half-duplex and wherein the monitoring comprises detecting a number of late collisions occurring.

3. The method of claim 1, wherein the operating duplex mode of the first node is half-duplex and wherein the monitoring comprises determining whether a shared media is used by the first node and second node.

4. The method of claim 3, wherein the determining whether a shared media is used comprises inspecting the destination addresses of packets received at the first node.

5. The method of claim 1, wherein the operating duplex mode of the first node is full-duplex and wherein the monitoring comprises determining whether excessive jam signals are detected at the first node.

6. The method of claim 1, further comprising:
changing duplex mode of the first node based on the at least one condition.

7. The method of claim 1, further comprising providing a visible indication of a corrective action to potential duplex-mismatch between the first and second nodes.

8. A computer-readable medium comprising instructions stored thereon which when executed by a machine cause the machine to:
identify an operating duplex mode of a first node;
monitor at least one condition potentially associated with duplex mismatch between the first node and a second node; and
provide a record of the at least one condition.

9. The computer-readable medium of claim 8, wherein the operating duplex mode of the first node is half-duplex and wherein the instruction to monitor comprises an instruction to detect a number of late collisions occurring.

10. The computer-readable medium of claim 8, wherein the operating duplex mode of the first node is half-duplex and wherein the instruction to monitor comprises an instruction to determine whether a shared media is used by the first node and the second node.

11. The computer-readable medium of claim 10, wherein the instruction to determine whether a shared media is used comprises an instruction to inspect the destination addresses of packets received at the first node.

12. The computer-readable medium of claim 8, wherein the operating duplex mode of the first node is full-duplex and wherein the instruction to monitor comprises an instruction to determine whether excessive jam signals are detected at the first node.

13. The computer-readable medium of claim 8, further comprising an instruction to change duplex mode of the first node based on the at least one condition.

14. The computer-readable medium of claim 8, further comprising an instruction to provide a visible indication of a corrective action to potential duplex-mismatch between the first and second nodes.

15. An apparatus comprising:
logic to identify an operating duplex mode of a first node;
logic to monitor at least one condition potentially associated with duplex mismatch between the first node and a second node; and
logic to provide a record of the at least one condition.

16. The apparatus of claim 15, wherein the operating duplex mode of the first node is half-duplex and wherein the logic to monitor comprises logic to detect a number of late collisions occurring.

17. The apparatus of claim 15, wherein the operating duplex mode of the first node is half-duplex and wherein the logic to monitor comprises logic to determine whether a shared media is used by the first node and second node.

18. The apparatus of claim 17, wherein the logic to determine whether a shared media is used comprises logic to inspect the destination addresses of packets received at the first node.

19. The apparatus of claim 15, wherein the operating duplex mode of the first node is full-duplex and wherein the logic to monitor comprises logic to determine whether excessive jam signals are detected at the first node.

20. The apparatus of claim 15, further comprising logic to change a duplex mode of the first node based on the at least one condition.

21. The apparatus of claim 15, further comprising logic to provide a visible indication of a corrective action to potential duplex-mismatch between the first and second nodes.

22. A system comprising:
a host system comprising a processor and a memory device;
a bus; and
a chipset to communicatively couple the host system to the bus, wherein the chipset comprises a network interface and wherein the host system comprises:
logic to identify an operating duplex mode of the network interface;
logic to monitor at least one condition potentially associated with duplex mismatch between the network interface and a second node; and
logic to provide a record of the at least one condition.

23. The system of claim 22, wherein the host system further comprises logic to change a duplex mode of the network interface based on the at least one condition.

24. The system of claim 22, wherein the network interface further comprises logic to provide a visible indication of a corrective action to potential duplex-mismatch between the first and second nodes.
